(19) United States
(12) Patent Application Publication
(10) Pub. No.: US 2016/0137551 A1
(43) Pub. Date: May 19, 2016

(54) GEOSYNTHSESIS BINDER COMPRISING A CALCIUM- ALKALINE ACTIVATOR AND A SILICO-ALUMINOUS COMPOUND

(71) Applicant: COLAS, Boulogne Billancourt (FR)

(72) Inventors: Cedric LE GOUIL, BRETIGNY-SUR-ORGE (FR); Arnaud LEROY, SENLISSE (FR)

(21) Appl. No.: 14/940,412

(22) Filed: Nov. 13, 2015

(30) Foreign Application Priority Data
Nov. 13, 2014 (FR) 1460954

(51) Int. Cl. C04B 12/04; C04B 28/26

(52) U.S. Cl. CPC C04B 12/04; C04B 28/26; C04B 2111/00732

(57) ABSTRACT

The geosynthetic binder dry composition includes at least: an alkalino-calcium type activator including at least lime and an alkaline salt, which can suitably react together so as to form in situ a base in the presence of water, and a silico-aluminous compound, including an amount of calcium oxide higher than or equal to 15%, by weight, as compared to the silico-aluminous compound total weight, characterized in that the binder dry composition includes, by weight, as compared to the total weight, from 45 to 95% of the silico-aluminous compound, from 2 to 25% of lime and from 3 to 30% of an alkaline salt. The material including the geosynthetic binder dry composition and water, a method for producing the geosynthetic binder dry composition, and a method for producing the material are also described.

### TECHNICAL FIELD OF THE INVENTION

The present invention relates to building materials used in the transport infrastructure field (roads and railways), to embankments and supporting structures for buildings and civil engineering, wherein such structures, embankments and infrastructures will be hereafter referred to as <<structures>>.

In particular, the present invention relates to a geosynthetic binder dry composition based on an alkaline activator and on a silico-aluminous compound designed for example for the treatment of soils and granular materials. The present invention also relates to a material comprising said geosynthetic binder and optionally aggregates.

The present invention further relates to a method for preparing the geosynthetic binder dry composition, as well as to a method for processing the abovementioned material.

### TECHNICAL BACKGROUND

The treatment of soils and granular materials through the use of one or more hydraulic binders is a method which consists in incorporating within these soils or materials, this or these added ingredient(s) in the presence of water (natural and/or added water) and in mixing them together more or less intimately in situ or within industrial installations until a relatively homogeneous material is obtained, making it possible to provide it with new properties.

This is a treatment, which, using the chemical affinities of the materials and of the binder, enables to improve the simple mechanical treatment, like compaction.

The treatment of the materials used for making embankments, sub-base layers and sub-bases conceived for making transport infrastructures aims at making use of a material, which without modification of its intrinsic parameters, would not have the required initial characteristics.

There are several reasons for this treatment:
to improve too wet soils, whatever there are soils in place for making the work advance on the sites or soils to be reused as embankments;
to provide rigid and weather-stable roadbeds so as to run in the work sites and to carry out a road base course;
or, starting from these soils, to form structural embankments, road base courses or road bases for <<structures>>, while preferably providing performances that have been improved in the long run.

Nowadays binders are based on lime and/or on hydraulic binders produced by the cement industry. Such binders are mainly based on clinker, slag cements, fly ashes or on pozzolans activated by lime or a sulfo-calcium-type compound.

Known from the state of the art is for example JPH 10 168451, which describes a grout for treating a soil, which comprises for 1 m³ (a) a hardening agent in a liquid form containing an aggregated slag (50-500 kg), a powdered calcium compound like quick lime, hydrated lime or gypsum (10-300 kg), a cement fluidifier (from 0.1 to 5 kg), and (b) a liquid component comprising especially: a colloidal silica (5-150 kg) and a compound especially selected from sodium carbonate, potassium carbonate (10-200 kg) and (c) water to complement.

The setting mechanism of these hydraulic binders is based on the mineral compound dissolution and their crystallization within the aqueous medium. The thus produced crystals create bonds between the soil components or the granular elements.

These methods for treating soils and granular materials for hydraulic binders are well known and codified. Binders are the object of standards and guides. They are highly used in France as well as in many other parts of the world.

Indeed, they are deposited in a cold state and offer many technical and economical advantages. They enable indeed to substantially minimize the natural aggregate extractions. Such extractions of quarry materials could be reduced to come close to zero in case of positive existing soil conditions. Reducing the use of quarry materials as a consequence enables to reduce the transport operations for the construction of the <<structures>>, and to minimize the discomfort caused to the road users and to the side residents living near the work sites.

However, the expected result sometimes is not obtained, or disorders (swellings) do even appear and make it necessary to go back over the whole structure.

Such disorders can be explained for example by the crystallization of sulfate-type secondary species such as ettringite or thaumasite. Their crystallization results from a chain reaction, which most of the time implies gypsum or sulfides naturally present in many soils in the presence of water.

Ettringite in particular has a swelling ability in the presence of water: it could be observed that the variation in volume of the mineral is of about 30%. When ettringite forms within a soil or an added material, the letter becomes substantially less stable: there are risks that swelling occurs because of the support, which can sometimes cause crumbling and/or mudslides. In the case of a treated soil and/or added materials intended to be used for the construction of <<structures>>, they may then suffer from cracks, crevasses and/or differences in levels, which are detrimental to the use of such <<structures>>. For example, a soil comprising about 2% by weight of sulfates does typically swell in the middle or long term due to the formation of ettringite.

Also the presence of organic materials, such as humic acids or fulvic acids, within the soils/materials to be treated may inhibit the setting of current binders.

When such soils or aggregates are encountered, they will preferably be identified prior to starting the works and other construction methods will be used. It is sometimes even necessary to remove the soils in place and to replace the same with new soils or materials, for making embankments and sub-base layers. This type of solution is expensive and strongly impacts the environment.

Research focusing on the development of methods for treating these soils and aggregates that are unsuitable for the treatment of traditional hydraulic binders has been effected, so as to make it possible to use the same in road building.

Various solutions have been suggested to date.

FR 2 741 630 describes in particular a method for treating a swelling soil onto which has been deposited a combination of slaked lime, aluminum hydroxide and/or a binder selected from cement slags, pozzolans, flying ashes and silica fumes.

However, this method as a drawback suffers from not imparting a sufficient mechanical resistance and has excessively high production costs.

International Publication WO 2010/085537 describes a geopolymer composite binder for concrete or cement, comprising a dry mixture of a binder and a liquid alkaline activator. In particular, the dry mixture may contain: (i) at least one flying ash material comprising 15% by weight or less of calcium oxide; (ii) at least one gelling agent, (iii) at least one hardening agent with a different composition as compared to that of the flying ash material(s) and (iv) optionally a set controlling agent. In this document, the liquid alkaline activator is an aqueous solution of metal hydroxide and metal silicate, such as an alkali metal silicate (Na₂SiO₃) or a solution of metal hydroxide and fumed silica. However, the composite binder composition described in this document unfortunately is corrosive and its use is dangerous.

JP S58 145654 describes a hardenable composition, which can be used as a building material comprising a cement slag, gypsum, lime, active hydrated alumina and optionally methylcellulose. It is mentioned that active hydrated alumina may be active aluminum hydroxide or a fresh alumina gel, resulting from the reaction of an alkaline substance with an aluminum water-soluble salt. However, such hardenable composition has excessively high production costs.

International Publication WO 2007/109862 discloses a cement dry composition comprising an alkaline multi-phase aluminosilicate material that can suitably provide an alkali source and a soluble silicate. In particular the alkaline multi-phase aluminosilicate material (a) is formed through a chemical activation (temperature rise) or a mechanical activation (i) of an aluminosilicate material in the presence (ii) of an alkaline material. In the examples, the alkaline multi-phase aluminosilicate material is activated by means of soda (NaOH), potash (KOH) and/or sodium carbonate. As a consequence, the aluminosilicate material described in this document suffers from several drawbacks: it first requires a chemical activation (thermal activation) or a mechanical activation, thereafter it requires the use of dangerous substances (soda).

US 2005/160946 relates to cement-based materials, and in particular to the use of a mixture comprising stainless steel slag and a geopolymer binder as a total or a partial substituent for cement in a concrete composition. In particular, the cementitious material may comprise: as a geopolymer binder, an aluminum silicate derived for example from flying ashes, and an activator (calcium bromide, calcium oxide, etc).

FR2 839 970 describes a geopolymer binder or cement made of an amorphous vitreous matrix within which mellilite particles, alumino-silicate particles and quartz particles are embedded, these particles having a mean diameter lower than 50 microns. The amorphous vitreous matrix is made of a geopolymer compound of the poly(sialatedisiloxo) type, with the approximate chemical formula (Na,K,Ca)(—Si—O—Al—O—Si—O—Si—O), or (Na,K,Ca)-PSDS.

To obtain such geopolymer binder or cement, a reaction mixture has to be hardened, which comprises: a) a highly altered, residual soil rock, of the granite type, wherein the kaolinization process is in an advanced stage; b) a calcium mellilite glass, wherein the glass part is higher than 70% by weight, as compared to the total weight and c) a soluble alkaline silicate, wherein the mole ratio of (Na,K)₂O:SiO₂ is between 0.5 and 0.8.

However, such geopolymer binder or cement, as a drawback, is unfortunately highly corrosive and dangerous to use. Moreover, such solution is expensive and the raw materials that are used are not easily available.

Although the binders of the prior art have been subjected to substantial improvements, their development is still very limited or non-existent because of the hereabove mentioned disadvantages, which thus means that they bring more constraints than benefits. To date, the general rule which applies is not to treat sulfate-containing soils and -granular materials beyond a certain percentage: 0.7% is the threshold the most commonly agreed upon.

There is thus still a need for new binder compositions, which would make it possible to treat soils and/or granular materials containing in particular sulfur, while preferably preventing unacceptable side effects related to their use, such as the resulting ettringite or thaumasite formation.

It is an object of the present invention to propose a new dry binder composition avoiding at least partially the previously mentioned drawbacks.

### Aim of the Invention

To remedy to the drawback previously mentioned in the state of the art, the present invention provides a geosynthetic binder dry composition, comprising at least:
an alkalino-calcium type activator comprising at least lime, such as hydrated lime and an alkaline salt which can suitably react together so as to form in situ a base, preferably a strong base, in the presence of water, and
a silico-aluminous compound comprising an amount of calcium oxide higher than or equal to 15%, by weight, as compared to the silico-aluminous compound total weight,
   characterized in that the binder dry composition comprises, by weight, as compared to the total weight, from 45 to 95% of said silico-aluminous compound, from 2 to 25% of lime and from 3 to 30% of an alkaline salt.

It should be noted that according to the invention the amounts of CaO which can be derived from the lime of the alkalino-calcium type activator are not included within the amounts of CaO which may be present in the silico-aluminous compound.

As used herein, a <<geosynthetic binder>> is intended to mean a geopolysynthetic binder resulting from a mineral polycondensation caused by an alkali-activated reaction, called geosynthesis, as opposed to traditional hydraulic binders, wherein hardening results from a hydration of the calcium aluminates and calcium silicates.

As used herein, a <<dry>> composition is intended to mean a composition in an anhydrous form, that is to say only comprising water as traces, i.e. having for example a weight content lower than or equal to 5% as compared to the composition total weight.

For the remainder of the specification, unless otherwise specified, a range of values from <<X to Y>> or <<between X and Y>>, as used herein is intended to include both values of X and Y.

The geosynthetic binder dry composition may also present the following characteristics, either taken individually or considered as any technically possible combination:
said silico-aluminous compound may comprise an amount of calcium oxide higher than or equal to 25%, by weight, as compared to the silico-aluminous compound total weight;
said silico-aluminous compound may comprise, by weight, as compared to the total weight, at least: from 25 to 55% of calcium oxide (CaO), from 3 to 25% of alumina (Al₂O₃) and from 20 to 50% of SiO₂;
said silico-aluminous compound may comprise, by weight, as compared to the total weight, at least: from 35 to 45% of calcium oxide (CaO), from 5 to 15% of alumina (Al₂O₃) and from 30 to 45% of SiO₂;
the Si/Al molar ratio of said silico-aluminous compound varies from 0.1 to 6, preferably from 1 to 4;
the binder composition may comprise, by weight, as compared to said binder composition total weight, from 65 to 85% of said silico-aluminous compound, from 5 to 20% of lime, preferably hydrated, and from 10 to 25% of alkaline salt;
the alkaline salt of the alkalino-calcium type activator may be potassium carbonate, sodium carbonate, potassium silicate, sodium silicate or any combination thereof;
the binder dry composition may comprise in addition a sulfate source;
the binder dry composition does not require any chemical and/or mechanical activation step. In particular, the binder dry composition according to the invention does not require any thermal activation.

The present invention further relates to a material comprising a soil, an aggregate or the mixture thereof, said soil, said aggregate or said mixture thereof comprising optionally a sulfate source, characterized in that it comprises moreover water and a geosynthetic binder dry composition, such as described hereabove.

As used herein, a <<soil, an aggregate or the mixture thereof comprising a sulfate source>> is intended to mean a soil, an aggregate or the mixture thereof comprising sulfates to a threshold for example higher than or equal to 0.5%, preferably higher than or equal to 0.7%, by weight, as compared to the soil and/or aggregate total weight.

In the frame of the present invention, a soil may be defined according to the NF P 11-300 Standard <<Classification of materials for use in the construction of embankments and capping layers of road infrastructures>>. This standard enables to classify soils according to a number of parameters:
Class A—fine soils,
Class B—sandy soils and gravelly soils with fines,
Class C—soils comprising fines and coarse elements,
Class D—soils insensitive to water.

As an example, the soil may be for most part thereof composed of gravel-sand mixtures, marls, clays or alluvia.

Also according to the invention, an aggregate may correspond to natural, synthetic or recycled aggregates, in particular according to the NF P 18-545 Standard, and is typically composed of sands, fine gravels, fillers, fine sands, dusts or any combination of these components.

In particular, the binder dry composition represents from 1 to 30%, preferably from 2 to 20%, by weight, as compared to the material total weight.

Moreover, a fraction of sulfates, sulfides or other sulfur-type elements is present in the material in an amount ranging from 0.7 to 20%, by weight, as compared to the material total weight.

The present invention also relates to a method for producing a geosynthetic binder dry composition such as described hereabove, comprising at least the following step: mixing for a time period ranging from 0.5 minutes to 15 minutes, in a powder mixer: an alkalino-calcium type activator comprising lime and an alkaline salt, with a silico-aluminous compound comprising an amount of calcium oxide higher than or equal to 15%, by weight, as compared to the silico-aluminous compound total weight.

Lastly, the present invention further relates to a method for producing a material such as defined hereabove, comprising a geosynthetic binder dry composition such as described hereabove and comprising at least the following steps consisting in:
(i) preparing a dry binder composition such as defined hereabove;
(ii) preparing a soil or an aggregate or the mixture thereof comprising optionally a sulfate source;
(iii) spreading the binder dry composition onto the soil and/or the aggregate of step (ii);
(iv) mixing the soil and/or the aggregate obtained in step (iii);
(v) optionally adding mixing water during step (iii) and/or during and/or after the mixing step (iv) of the binder dry composition with the soil and/or the aggregate, so as to obtain said material.

This water addition depends on the water contained and measured beforehand in the soil and/or in the aggregate.

In particular, steps (iii) and (iv), even steps (iii) to (v), may be replaced with a production in a central plant, continuously or discontinuously, so as to obtain said material which will be ready to be suitably used in a work site.

### DETAILED DESCRIPTION OF AN EMBODIMENT

The following description together with the appended drawings, given as non limiting examples, will help better understand the object of the invention and the way it may be put into practice.

On the appended drawings:

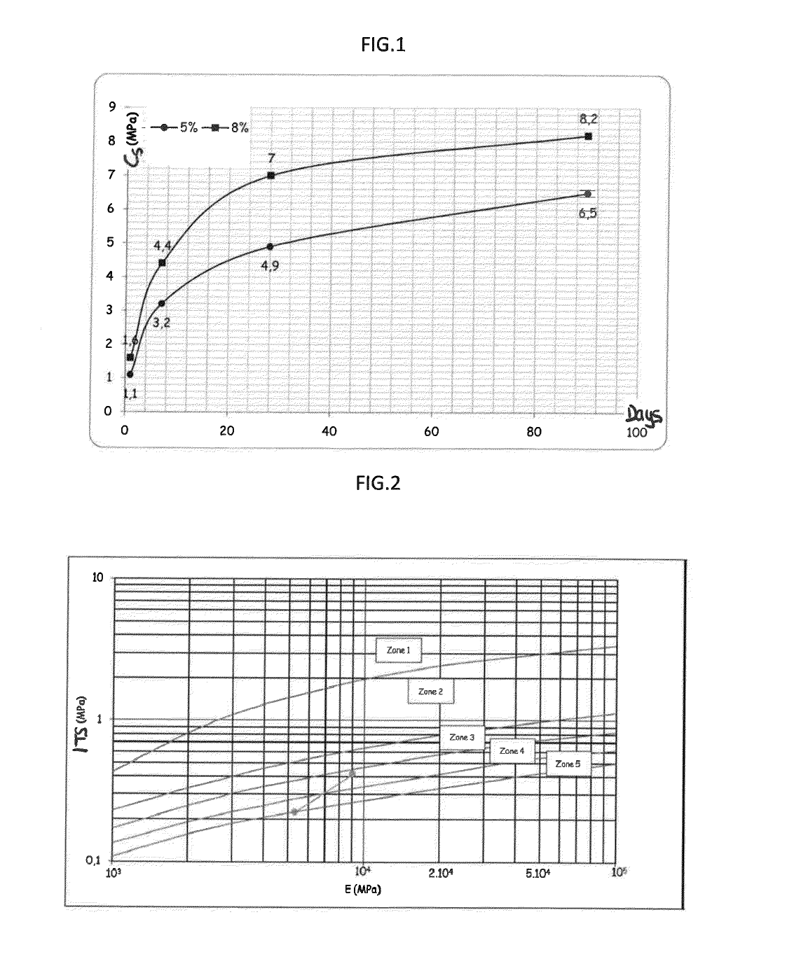

FIG. 1 is a diagram showing the direct compressive strength Cs as a function of time in days for a soil B5 comprising by weight, as compared to the material total weight, either 5% or 8% of the binder of the invention; and

FIG. 2 is a diagram showing the evolution of the indirect tensile strength ITS, between day 7 and day 28, as well as the modulus of elasticity E (MPa) for soil B5 on FIG. 1 treated with 5% of the binder of the invention.

The applicant focused on the development of new binder compositions adapted to the requirements of <<structure>> professionals (like concrete structures for building and treatments for soils, aggregates for transport infrastructures, etc.), that is to say capable of improving the mechanical resistances and especially the direct or indirect tensile strengths of materials incorporated thereto, while reducing in particular the emissions of CO₂ of the current binders. It also focused on the development of new binder compositions intended to treat problematic soils or aggregates, such as sulfate-containing soils or soils rich in organic materials.

With this end in mind, the present invention relates to a geosynthetic binder dry composition comprising at least:
an alkalino-calcium type activator comprising at least (a) lime, such as hydrated lime and (b) an alkaline salt, such as sodium carbonate or potassium carbonate, said lime (a) and said alkaline salt (b) being able to react together to form in situ a base, preferably a strong base (KOH, NaOH, etc.) in the presence of water, and
(c) a silico-aluminous compound, comprising an amount of calcium oxide higher than or equal to 15%, by weight, as compared to the silico-aluminous compound total weight,

characterized in that the binder dry composition comprises, by weight, as compared to the total weight, from 45 to 95% of said silico-aluminous compound, from 2 to 25% of lime and from 3 to 30% of the alkaline salt.

Thanks to its characteristics and, in particular, to the combination of both alkalino-calcium type activator and specific silico-aluminous compound, the binder dry composition of the invention has many advantages.

It enables to treat soils and/or aggregates in place and in particular of soils and/or aggregates having a relatively high amount of sulfates (for example higher than 0.7% by weight) for making stable, homogeneous and durable embankments or sub-base layers, while possessing mechanical characteristics, which can be compared, for example, to those of a gravel-cement mixture or of a grave treated with hydraulic binder.

The applicant in particular surprisingly discovered that combining an alkalino-calcium type activator (like hydrated lime with an alkaline salt, for example sodium carbonate or potassium carbonate), with a silico-aluminous compound comprising a minimum amount of calcium oxide enables to improve the compressive strength, and thus the mechanical properties of a soil or an aggregate to which it is added.

Indeed, as can be observed from the test results illustrated in the present application, the geosynthetic binder dry composition of the invention in some cases improves the compressive strength by more than 85%, as compared to other tested binder compositions (see Table 7).

Moreover, the composition ensures a good load distribution on the support, thanks to the rigidity of the material or the thus obtained new structure.

Also thanks to such characteristic, the composition according to the invention ensures a good behavior in hot weather with no deformation, as well as a good behavior towards freeze-thaw cycles.

In addition, the treatment of soils in place with the composition of the invention can be easily adapted to the operating requirements.

The dry binder composition according to the invention is economic and easy to implement (high availability of the invention components).

Without wishing to be bound by any theory, it seems that the thus defined composition would cause a chemical setting which would widely imply the various elements taking part to the formation of secondary ettringite or thaumasite, responsible for the previously mentioned disorders. Especially this composition would enable to consume the sulfate, aluminum and calcium water-soluble ions present in both the binder and also potentially in the soil or the granular material to be treated.

Moreover, the geosynthetic binder dry composition according to the invention advantageously strongly limits the H.S.E. impacts (Hygiene, Security, and Environment) on the application staff. The water-activated hydrated lime and alkaline salt, like sodium carbonate, enable to produce an alkaline activator through the formation in situ of a base, typically a strong base, such as soda, which will <<attack>> the particular silico-aluminous compound of the invention, as well as the other silico-aluminous compounds (clays, etc.) optionally present in the treated soil/aggregate. This would lead to the reinforcement of the mechanical properties of the treated material.

Lastly, the composition according to the invention as an advantage uses an alkaline activator also favorable towards the HSE constraints. Indeed the alkaline activation, of the sodium or potassium type, is effected within the binder-containing material after the introduction of added water. The base is formed in situ within the treated material and thus does not directly contact the user.

Such as previously indicated, the binder of the invention comprises an alkalino-calcium type activator, comprising (a) lime, such as hydrated lime (Ca(OH)₂), and (b) an alkaline salt.

Such lime (a), which may be hydrated, slaked or caustic (a), may in particular comprise an amount by weight as compared to the lime total weight of at least 50%, preferably from 50 to 99.9%, of Ca(OH)₂. A range of values from 50 to 99.9% includes in particular the following values: 50, 55, 60, 65, 70, 75, 80, 85, 90, 95, 96, 97, 98, 99. Hydrated lime is typically preferred.

Lime (a) generally comes as a powder.

In particular, at least 50%, preferably from 50 to 99%, and especially at least 90% of hydrated lime (a) may go through a 200 μm-sieve, or even a 90 μm-sieve. Also, a range of values from 50 to 99% includes in particular the following values: 50, 55, 60, 65, 70, 75, 80, 85, 90, 95, 96, 97, 98, 99.

As an example, the maximum diameter (Dₘₐₓ) is lower than or equal to 2000 μm, or even lower than or equal to 200 μm.

It may present a Blaine specific surface area higher than or equal to 3000 cm²/g, preferably ranging from 15000 to 20000 cm²/g.

The binder also comprises (b) an alkaline salt.

An alkaline salt according to the invention may be selected from: sodium carbonate (Na₂CO₃), potassium carbonate (K₂CO₃), sodium silicate (Na₂SiO₃) and potassium silicate (K₂O₅Si₂), as well as any combination thereof.

Typically, the alkaline salt (b) has a purity level that is higher than or equal to 80% and preferably higher than or equal to 95% and is used in a powdered form. Alkaline salt grains have a mean diameter that is typically lower than 1000 μm.

In particular, the silico-aluminous compound (c) comprises an amount of calcium oxide that is higher than or equal to 15%, by weight, as compared to the silico-aluminous compound total weight.

A calcium oxide content higher than or equal to 15% means a calcium oxide content higher than or equal to 15%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 58%, 60%, 63%, 65%, 68%, 70%, or any range between those values.

Typically, said silico-aluminous compound (c) comprises at least, by weight, as compared to the silico-aluminous compound total weight: from 25 to 55% of calcium oxide (CaO), from 3 to 25% of alumina (Al₂O₃) and from 20 to 50% of SiO₂.

According to an embodiment, said silico-aluminous compound (c) comprises at least, by weight, as compared to the silico-aluminous compound total weight: from 35 to 45% of calcium oxide (CaO), from 5 to 15% of alumina (Al₂O₃) and from 30 to 45% of SiO₂. The particular silico-aluminous compound of the invention may comprise moreover traces of titanium dioxide or alkaline-earth oxides like MgO, Fe₂O₃, TiO₂, SO₃, Na₂O or K₂O.

The reactive silica percentage may be for example higher than or equal to 15% by weight, preferably may range from 15 to 50% and more preferably from 25 to 45% by weight; whereas the reactive alumina percentage may be for example higher than or equal to 2% by weight, preferably may range from 2 to 25% by weight and most preferably from 5 to 15% by weight, as compared to the silico-aluminous compound total weight. Moreover, the CEC value (cmol(+)/kg) may especially vary from 2 to 25, preferably from 5 to 15.

Typically the Si/Al molar ratio of the silico-aluminous compound according to the invention varies from 0.1 to 6, preferably from 1 to 4, or within any range between those values.

The silico-aluminous compound (c) according to the invention typically comes as a powder. In particular, at least 50%, preferably from 50 to 99%, and especially at least 90% of the silico-aluminous compound may go through a 32 μm-sieve. As an example, the mean diameter (D₅₀) may range from 2 to 50 μm, preferably from 2 to 20 μm and in particular from 5 to 15 μm.

It may have a Blaine specific surface area higher than or equal to 2000 cm²/g, preferably ranging from 2000 to 6000 cm²/g and in particular from 4000 to 5000 cm²/g.

The binder of the invention may also comprise (d) a sulfate source, like calcium sulfates (gypsum (CaSO₄²⁻)) or magnesium sulfates, especially if the soil and/or the aggregates to be treated do not contain sufficiently thereof. The weight content of such sulfate source, as compared to the binder total weight, may vary from 10 to 30%, preferably from 15 to 20%.

Such addition of a sulfate source facilitates the setting, the hardening and the water stability of the binder dry composition. The sulfate source may also be integrated to the binder in a powdered form.

The binder composition according to the invention may moreover optionally comprise additives, intended to control the setting kinetics (setting accelerators or retarders). These additives are well known from the person skilled in the art.

In order to make the binder dry composition react (in other words so that the reaction proceeds) the binder has to be in contact with water (catalyst). The water content may be determined classically by means of the Proctor test and will be determined by a person skilled in the art. Depending on the nature of the material to be treated and on the implementation mode, the optimal mixing water ratio can vary, for example, from 1 to 50% and in particular from 5 to 25%. The water content may also be classically determined using any other test known from the person skilled in the art, that would be better adapted to the material to be treated, such as the Abrams slump cone test used for concretes.

The lime (a) and the alkaline salt (b), for example a sodium or a potassium salt, will thus form in situ together with water an alkaline activator (base), respectively caustic soda or potash. The latter will then react with the particular silico-aluminous compound (c) of the invention so as to surprisingly form a binder having improved properties. As illustrated in the test experiments which follow, combining these three compounds make them act in a synergistic manner to improve the mechanical resistances of the treated soil and/or aggregates.

The dry binder composition of the invention comprises, by weight, as compared to the dry binder composition total weight, from 45 to 95% of said silico-aluminous compound, from 2 to 25% of lime, preferably of hydrated lime and from 3 to 30% of an alkaline salt such as sodium carbonate.

In particular, the binder dry composition according to the invention, comprises, by weight, as compared to the dry binder composition total weight, from 65 to 85% of said silico-aluminous compound, from 5 to 20% of lime, preferably of hydrated lime and from 10 to 25% of an alkaline salt such as sodium carbonate.

In particular, the mean diameter of the binder dry composition according to the invention (D₅₀) varies from 1 to 100 μm, preferably from 5 to 60 μm and most preferably from 5 to 30 μm.

The present invention also relates to a method for producing a dry binder composition such as defined hereabove.

Said method comprises at least the following step: mixing for a time period ranging from 0.1 minute to 15 minutes, preferably from 0.5 to 10 minutes, and in particular from 1 to 5 minutes, in a powder mixer, the binder dry composition such as defined hereabove, i.e. comprising at least:
an alkalino-calcium type activator, comprising for example (a) hydrated lime and (b) an alkaline salt, such as sodium carbonate or potassium carbonate, and
(c) a silico-aluminous compound comprising an amount of calcium oxide higher than or equal to 15%, by weight, as compared to the silico-aluminous compound total weight.

The mixer to be suitably used for the method of the invention may be of the horizontal, planetary, blade or cone type.

For example, the mixing speed can be set between 1 and 220 rpm, most preferably it will be set at 60 rpm for a planetary mixer.

This method enables to implement regular batches.

Moreover, the equipment as well as the operation parameters of this equipment are those that are classically used for preparing standard binder compositions and can be suitably adapted by a person skilled in the art.

Of course the production method according to the invention may comprise all the geosynthetic binder dry composition characteristics as described hereabove.

The dry binder composition of the invention is in particular intended to treat soils so as to reinforce their mechanical properties.

Preferably, the soil and/or the aggregate comprises a sulfate source such as described hereabove.

According to the invention, the abovementioned binder dry composition may be employed for the treatment of soils and/or aggregates in place using classical procedures, i.e. through preceding spreading of the binder onto the soil and/or aggregates with a suitable batching method (volumetric or quantitation type) or through positioning of the binder-containing bags onto the soil. The binder spreading is followed with the soil mixing-in place according to the defined thickness using a mobile mixer provided to that end or a pulvimixer. The mobile batching device enables to control the thickness of the treated soil so as to control the composition of the mixture. The amount of added water is determined through previous measurement of the water contained in the soil, thereafter addition of the water balance required for the binder to set. Such water addition may be effected before, during or after having mixed-in place the binder together with the soil and/or the aggregates. The equipment to bring water must ensure the planned batching control.

Moreover, the present invention further relates to a material or a structure comprising a soil or an aggregate, or the combination thereof, with a sulfate source as an option, characterized in that it comprises water and a dry binder composition such as defined hereabove.

Typically, the binder dry composition represents, by weight, as compared to the material total weight, from 1 to 30%, preferably from 2 to 20%.

As an example, said material may comprise a fraction of sulfates, sulfides or other sulfur-type elements in an amount ranging from 0.7 to 20% or within any range between these values, by weight, as compared to the material total weight.

Preferably, the mixing water ratio varies from 1 to 50% by weight, preferably from 5 to 25% by weight. The mixing water ratio is defined as the ratio of water to dry material amount by weight.

The water content will be preferably determined using the Proctor test (NF P 98-231-1) known from the person skilled in the art and commonly used in the road construction field. Thus the specialist will be able to adapt the mixing water ratio depending on the soil and/or aggregates to be treated, or on the binder dry composition or on the expected workability.

In particular, the material or the structure may be obtained according to the following production method, which comprises at least the following steps consisting in:
i) preparing a dry binder composition such as defined hereabove;
ii) preparing beforehand a soil, an aggregate or the combination thereof, said soil, aggregate or combination thereof comprising optionally a sulfate source;
iii) spreading the binder dry composition onto the soil and/or the aggregate of step (ii);
iv) mixing the soil and/or the aggregate obtained in step (iii);
v) optionally, adding mixing water during steps ii) to iv), either before, during or after the mixing-in place of the binder dry composition together with the soil and/or the aggregate (this addition depends on the water contained and previously measured in the soil and/or the aggregate);
vi) optionally, grading and compacting the material;
vii) and optionally providing a protection or a surfacing thereto.

Typically, the processing method of the material according to the invention employs technologies and equipments that are usually used for standard materials obtained from a hydraulic binder combined with a soil and/or an aggregate.

Step ii) of preparation of a soil and/or an aggregate may comprise the breaking up of the soil, as well as the reprofiling thereof, or its possible granular correction by adding new materials, or by crushing, or by preselecting, or using the three solutions together.

As an example, step iv) may be effected by a mixer. A mixer to be suitably used for the present method may be provided movable on a treating-in place machine, fitted with rotors and a horizontal or vertical shaft.

Preferably, the mixing speed will be set between 1 and 220 rpm, most preferably will be equal to 150 rpm for a treating-in place machine fitted with a horizontal shaft. Step (ii) of mix-in place of the soil or the aggregate may be carried out for 0.1 to 15 minutes, preferably for 0.5 to 10 minutes and most preferably for 2 minutes.

A person skilled in the art will be able to adapt the mixing speed and the duration of this step depending on the soil/aggregate to be treated as well as on the available equipment.

Typically, the mixing water ratio varies from 1 to 50% by weight, preferably from 5 to 25% by weight. The mixing water ratio is defined as the ratio of water to dry material amount.

In a second embodiment, the material may be prepared in a central plant fitted with a horizontal mixer, a cone mixer, a blend mixer, a planetary mixer or with a mixer having planetary rotating blades. In particular, in such an embodiment, steps (iii) and (iv), even (iii) to (v), may be replaced with a production in a central plant, continuously or discontinuously, prior to using the obtained material or structure on a work site. In this way, the various components of the material can be directly combined in the central plant prior to being spread at the desired location.

Likewise, step (iv) of binder incorporation may be effected for a duration of 1 second to 5 minutes, preferably from 0.1 to 1 minute and most preferably equals 0.5 minute at a mixing speed ranging from 50 to 80 rpm.

The following examples are intended to illustrate the invention without limiting the same. Unless otherwise specified in the remainder of the specification, percentages are expressed in weight.

### EXAMPLES

A) Characterization

B)

Simple Compressive Strength Cs (NF EN 13286-41)

A test specimen containing a soil treated with the binder to be tested was submitted to compression until a fracture occurs. The maximum effort the test specimen could resist to was recorded and the compressive strength calculated.

In particular, the test consisted in putting a strain on a cylindrical test specimen, with diameter Ø 5 cm and with height h 10 cm (5×10), between two plates perpendicularly to its main axis, on a computer-controlled press, with a constant force applying velocity of 0.1 kN·s⁻¹.

The higher the Cs value, the better the mechanical resistance of the tested binder/cement-containing material.

Indirect Tensile Strength ITS (NF EN 13286-42)

NF EN 13286-42 Standard is used to determine the indirect tensile strength ITS. To that end, the plate must be brought into contact with the test specimen, then a load must be continuously and evenly applied with a speed not higher than 0.2 MPa/s.

The higher the ITS value, the better the mechanical resistance of the tested binder/cement-containing material.

Determination of the Modulus of Elasticity E (NF EN 13286-43)

NF EN 13286-43 Standard describes the test method to measure E. The modulus of elasticity provides data about the behavior of the tested material when submitted to stresses and characterizes the material rigidity.

The higher the modulus of elasticity, the lesser the material deformation under stress and thus, the stiffer the material.

Determination of the Compaction References of a Material NF P 94-093

(Proctor Curve)

This test enables to determine the water amount to introduce into a mixture for use in road construction. It was used for each test illustrated in the present application. The principle of such test consisted in humidifying a given material with various amounts of water, then in compacting, with each of the recorded water amounts, according to a standardized method and energy value.

For each of the considered water content values, the dry density of the material was determined and the curve of the dry density variations was plotted as a function of water content.

Generally speaking, this curve, called the Proctor curve, has a dry density maximum value obtained for a particular water content value.

B) Preparation of Two Binder Compositions

Two binder compositions of the invention (binder 1 and binder 2) were prepared from anhydrous sodium carbonate, hydrated lime (or slacked lime) Ca(OH)₂, and ground blast furnace slag.

In particular, hydrated lime had a chemical formula Ca(OH)₂ and the following composition:

| | |
|---|---|
| Total (CaO + MgO) | ≧90% |
| Ca(OH)₂ slacked lime content | ≧90% |
| CO₂ | ≦4% |
| MgO | ≦4% |
| S | ≦0.8% |
| H₂O | ≦2%. |

Moreover the lime had the following physical characteristics:
Particle size: passing through a sieve of 200 μm≧98%
Passing through a sieve of 90 μm≧93%
Penetration: >10 mm and <50 mm
Apparent density: 0.30/0.45
Blaine specific surface area: 15 000 to 20 000 cm²/g.

Sodium carbonate Na₂CO₃ used had a purity level >97% and a true density of 2.53 Mg/m³ and an indicative mean diameter (d50) of 60 μm (more than 95% of sodium carbonate did pass through a sieve of 200 μm).

The blast furnace ground slag had especially the composition illustrated in Tables 1 and 2 hereunder:

TABLE 1

| Compound | weight percent |
|---|---|
| CaO | 43.4 |
| SiO₂ | 37.1 |
| Al₂O₃ | 10.8 |
| MgO | 6.7 |
| Fe₂O₃ | 0.6 |
| TiO₂ | 0.5 |
| SO₃ | 0.1 |
| S²⁻ | 0.9 |
| Na2O | 0.34 |
| K₂O | 0.24 |
| Na₂O eq. | 0.46 |
| Cl⁻ | 0.01 |

TABLE 2

| | |
|---|---|
| Reactive silica (%) according to | 36.3 |
| NF EN 197-1 | |
| Reactive alumina (%) test method | 10.2 |
| GEOS | |
| CEC (cmol(+)/kg} | 10.0 |

The blast furnace ground slag had a Blaine specific surface area, as measured according to NF EN 196-6 Standard of 4450±300 cm²/g, a true density of 2,90±0.03 g/cm³ and an indicative mean diameter (d₅₀) of 12 μm (more than 95% of the slag did pass through a sieve of 32 μm).

The dry binder composition 1 according to the invention had the formulation described in Table 3 hereunder:

TABLE 3

| | binder 1 (% by weight) |
|---|---|
| ground slag | 74.6 |
| sodium carbonate | 14.7 |
| hydrated lime | 10.7 |

Binder 1 came as a white powder and had a true density of 2.82 Mg/m³ and a particle size 0/2 mm with 1 μm≦D50(%)≦100 μm (more than 80% of binder 1 did pass through a sieve of 50 μm and more than 60% of binder 1 did pass through a sieve of 20 μm).

Binder 2 according to the invention comprised moreover a sulfated additive in the form of plaster or gypsum, so as to facilitate the setting and improve the water stability of the binder of the invention.

Thus binder 2 had following formulation (Table 4):

TABLE 4

| | binder 2 (% by weight) |
|---|---|
| ground slag | 62.2 |
| sodium carbonate | 12.3 |
| hydrated lime | 8.9 |
| (sulfated additive) | 16.7 |

Binder 1 and binder 2 were prepared by mixing the various components together in a powder mixer of the horizontal type fitted with blades and rotating at a mixing speed of 60 rpm for a duration of 3 minutes.

C) Tests

For the following tests, binder 1 as described hereabove was used.

C.1: Storage Ability

A storage ability test was conducted so as to evaluate the shelf life of the binder of the invention. For this test, 94.4% by weight of a slightly argillaceous fine soil of type A1 (a mud that is typical of the Paris area with a methylene blue test value of 1.5 and 75% by weight of elements passing through a sieve of 80 microns) according to the Road Construction Technique Guide (GTR) were combined with 5.6% by weight of binder 1 according to the invention (the percentages given are expressed relative to soil A1+binder 1 total weight).

The combination was tested as follows:
by mixing in a blade mixer for soils of the <<cutter>> type during 30 seconds at a speed of 24 rpm (bowl) and 3000 rpm (blades) so as to homogenize soil A1,
thereafter by incorporating binder 1 and mixing-in the mixture soil+binder 1 during 30 seconds at a speed of 24 rpm (bowl) and 3000 rpm (blades), and
mixing after water addition (mixing water ratio of 15%, determined using the Proctor test) during 2 min at 24 rpm (bowl) and 3000 rpm (blades).

The results for compressive strength were as follows:

TABLE 5

| | Cs (MPa) | |
|---|---|---|
| | 24 hours | 7 days |
| Immediate molding after preparation of binder 1 | 1.8 | 2.7 |
| Molding with binder 1 after 1 month-aging in a | 1.3 | 2.3 |
| hermetic bucket | | |
| Molding with binder 1 after 7-month aging in a | 1.7 | 2.5 |
| hermetic bucket | | |

As a consequence, binder 1 according to the invention had a good shelf life.

C.2: Influence of the Silico-Aluminous Contribution Type

Various silico-aluminous sources were studied for comparison (clay, kaolin, flying ash) so as to demonstrate the specificity of the aluminous source according to the invention, i.e. in this example the ground blast furnace slag (HF) as described hereabove.

The tested formulations (weight percent) were as follows (Table 6):

TABLE 6

| | blast furnace | | | | sodium | hydrated |
|---|---|---|---|---|---|---|
| | slag | clay | kaolin | flying ash | carbonate | lime |
| F1 | 74.6 | — | — | — | 14.7 | 10.7 |
| F2 | — | 74.6 | — | — | | |
| F3 | — | — | 74.6 | — | | |
| F4 | — | — | — | 74.6 | | |

The mixing water ratio for this test was determined using the Proctor test NF P94-093 and ranged from 9.9 to 14% for formulations F1 to F4.

The material treated was a 0/4 mm calcareous sand. It came from the SMBP quarry, located Berchère-les-Pierre (28), France, which corresponds to a so called Beauce limestone. For this test, 83% by weight of calcareous sand 0/4 mm were combined with 17% by weight of binder 1 according to the invention (the percentages given are expressed relative to calcareous sand+binder 1 total weight).

The combination was tested as follows:
by mixing natural sand in a planetary mixer during 30 seconds at a speed of 60 rpm,
then mixing still at a speed of 60 rpm for 5 min a first fraction of water until the calcareous sand is saturated with water,
incorporating binder 1 and mixing-in the mixture sand+binder 1 for 30 seconds at a speed of 60 rpm, and
mixing after addition of a second water fraction so that the mixing water ratio ranged from 9.9 to 14% depending on formulas (as determined with the Proctor test) during 2 min at 60 rpm.

For each previous formulation, a compression test Cs according to Standard NF EN 13286-41 was conducted after 24 hours and after 7 days.

The result was as follows:

TABLE 7

% variation
relative to F1

| | Cs 24 h (MPa)) | Cs 7 days (MPa) | 24 h | 7 days |
|---|---|---|---|---|
| F1 | 13 | 18 | — | — |
| F2 | 1.4 | 2.7 | −89.23 | −85.00 |
| F3 | 0.7 | 1.9 | −94.62 | −89.44 |
| F4 | 1.3 | 3.1 | −90.00 | −82.78 |

Thus, the formulation of the invention F1 had a compressive strength which was much higher than the one obtained with other silico-aluminous compound sources. An improvement could be observed of more than 85% minimum, both after 24 hours and after 7 days.

The binder of the invention thus had a very good mechanical resistance.

C.3: Influence of the Invention's Binder Components

Aim of the test was to determine the mechanical performances (Cs) of the binder of the invention by withdrawing one by one the components so as to evaluate their influence.

The treated material was the calcareous sand 0/4 mm as previously defined. Batching with the binder of the invention (binder 1) and with comparative binders amounted to 17% by weight, as compared to sand+binder total weight. The production method for sand was the same as in the preceding test (C.2).

The binder formulations tested (weight percent) and Cs results are illustrated in Table 8 hereunder:

TABLE 8

| | Binder tested with calcareous sand 0/4 | | | Cs results | |
|---|---|---|---|---|---|
| | | | sodium | Cs 24 h | Cs 7 days |
| | blast furnace slag | hydrated lime | carbonate | (MPa) | (MPa) |
| F1 | 74.6 | 10.7 | 14.7 | 13 | 18 |
| F5 | 74.6 | 25.4 | — | 4.7 | 7 |
| F6 | 74.6 | — | 25.4 | 2.6 | 17 |
| F7 | 100 | — | — | 0.7 | 1.3 |

The mixing water ratio for this test was determined using the Proctor test NF P94-093 and was equal to 10.2% for Formulations F5 to F7.

As a consequence, this test demonstrated that associating three components of the invention, i.e. the silico-aluminous compound (blast furnace slag), hydrated lime and sodium carbonate enables to obtain outstanding mechanical resistances both after 24 hours and after 7 days, which is not the case when such an association is not used. Moreover, these compounds act in a synergistic way since the compression test result for Formulation F1 was markedly higher than the sum of the compression test results for Formulations F5 and F6 after 24 hours.

C.4: Batching Variations of Invention's Binder Components

As for Test C.3, this test was conducted on the calcareous sand 0/4 mm defined hereabove. Batching with the binder of the invention (binder 1-F1) and with comparative binders amounted to 17% by weight as compared to sand+binder total weight. The production method for sand was the same as in the preceding test (C.2).

The proportion between hydrated lime and sodium carbonate was kept constant: 58% by weight of sodium carbonate and 42%, by weight of hydrated lime, as compared to sodium carbonate+hydrated lime total weight.

The formulations F1, F8 and F9 tested according to the invention as well as compressive strength results are illustrated in Table 9 hereunder:

TABLE 9

| | Binder tested with | | | | |
|---|---|---|---|---|---|
| | calcareous sand 0/4 | | | Résultat Rc | |
| | blast furnace | hydrated | sodium | Cs 24 h | Cs 7 days |
| | slag | lime | carbonate | (MPa) | (MPa) |
| F1 | 74.6 | 10.7 | 14.7 | 13 | 18 |
| F8 | 50.0 | 21.0 | 29.0 | 6 | 7.5 |
| F9 | 90.0 | 4.2 | 5.8 | 9 | 16 |

The mixing water ratio for this test was determined using the Proctor test NF P94-093 and was equal to 10% for Formulations F8 to F9.

As a consequence, a blast furnace slag content according to the invention ranging from 50 to 90%, by weight, as compared to the binder total weight, gave satisfying compressive strength values, especially when the slag content was equal to 75% by weight and when the alkaline activator comprised, by weight, 58% of sodium carbonate and 42% of hydrated lime and when the binder represented 17% by weight in the 0/4 mm sand to be treated, relative to binder+sand total weight.

C.5: Evolution of Simple Compressive Strength Values Cs, to Indirect Strength ITS and Modulus of Elasticity

For this test, various ways to batch binder 2 of the invention were tested, i.e. with 5% by weight and 8% by weight thereof on a sandy or gravelly soil with fines, on a few argillaceous soil of the B5 type (GTR NF P 11-300), relative to binder+soil total weight.

The production method of the soil+binder 2 mixture was the same as the one described at point C.1, i.e.:
mixing in a planetary mixer for 30 seconds at a speed of 60 rpm so as to homogenize soil B5,
incorporating binder 2 and mixing-in soil B5+binder 1 mixture for 30 seconds at a speed of 60 rpm, then
adding water, then mixing again (mixing water ratio from 14 to 15.5% for 2 min at ? rpm.

The results for compressive strength Cs, indirect tensile strength ITS (also called diametral compressive strength) and modulus of elasticity are given on FIGS. 1 and 2.

Referring to these figures, it could be observed that compressive strength Cs and ITS values were fully satisfying, as well as the modulus of elasticity.

C.6: Binder Efficiency in a Sulfate-Containing Soil (the Percentages are Expressed by Weight Relative to the Component Total Weight)

For this test, a fine soil was treated, of the few argillaceous mud type, class A1 according NF P 11-300 Standard. This type of soil, if devoid of sulfates, may be treated according to the rules of art by incorporating, first 1% of quick lime, then 6% of normalized cement of the CEM I type.

The same type of soil, if containing sulfates, calcium sulfates especially, may suffer from swelling, which is detrimental to its use.

This could be verified experimentally by treating pure soil A1 by adding 1% of quick lime and 6% of cement CEM I to the same. Thereafter, to this A1 treated with quick lime and cement CEM I, were added 3% of plaster, which main component is calcium sulfate hemi-hydrate (CaSO₄(H₂O)_{1/2}) in order to obtain a sulfated soil.

Cylindrical test specimens sized 5×5 cm were molded for the two mixtures. The test specimens were then stored in water at 40° C. during 7 days, hooped in metal rings, for the test specimens intended to be measured as regards indirect tensile strength, and in plastic nets, for the test specimens intended to be measured as regards swelling.

For the natural soil with no sulfates, the results after a 3 day-storage were as follows:
ITS=0.78 MPa, Volume swelling Vs=0.2%: resistance was excellent (acceptability threshold: ≧0.2 MPa) and swelling very moderate (acceptability threshold: ≦5%)

For the soil enriched with 3% of plaster, the results were as follows:
ITS=0.60 MPa, Volume swelling Vs=12.5%: although the resistance remained excellent (acceptability threshold: 0.2 MPa), very strong swelling prevented any practical use of such a treatment.

As a comparison, the test on sulfated soil (i.e. on the soil enriched with 3% of plaster) was also conducted with binder 1 according to the invention with two proportions: 8% and 11%, by weight, relative to binder 1+soil+plaster total weight. For this test, binder 1 of the invention did not contain any sulfate additive (d).

It could be observed that the volume swelling Vs was equal to 2.3% for an amount of 8% binder 1 and to 4.9% for an amount of 11% binder 1. These values were lower than the tolerance limit and thus make it possible to envisage a use on work site.

The indirect tensile strength values ITS were respectively 0.75 and 0.82 MPa. The dry binder composition of the invention thus enables to treat industrially this type of sulfated soil.

In addition, also the natural soil with no sulfate was treated with binder 1 of the invention in amounts of 8% and 11%. However in both cases, binder 1 could not cause the setting and the measurements could not be effected. This shows that for some types of materials, especially the relatively fine ones, which contain an argillaceous fraction, even in a small amount, the presence of sulfates in the mixture ensures a minimum setting, as well as satisfying mechanical performances.

Although the invention has been described in conjunction with a particular embodiment, it should be understood that it is not in any manner limited thereto and that it includes all the technical equivalents of the means described, as well as their combinations, provided these are within the scope and the spirit of the invention.

1. A geosynthetic binder dry composition comprising at least:
an alkalino-calcium type activator comprising at least lime and an alkaline salt, which can suitably react together so as to form in situ a base in the presence of water, and
a silico-aluminous compound, comprising an amount of calcium oxide higher than or equal to 15%, by weight, as compared to the silico-aluminous compound total weight,
wherein the binder dry composition comprises, by weight, as compared to the total weight, from 45 to 95% of said silico-aluminous compound, from 2 to 25% of lime and from 3 to 30% of an alkaline salt.

2. The dry geosynthetic binder composition according to claim 1, wherein said silico-aluminous compound comprises an amount of calcium oxide higher than or equal to 25% by weight, as compared to the silico-aluminous compound total weight.

3. The dry geosynthetic binder composition according to claim 1, wherein said silico-aluminous compound comprises, by weight, as compared to the total weight, at least from 25 to 55% of calcium oxide (CaO), from 3 to 25% of alumina (Al₂O₂) and from 20 to 50% of SiO₂.

4. The dry geosynthetic binder composition according to claim 3, wherein said silico-aluminous compound comprises, by weight, as compared to the total weight, at least from 35 to 45% of calcium oxide (CaO), from 5 to 15% of alumina (Al₂O₃) and from 30 to 45% of SiO₂.

5. The dry geosynthetic binder composition according to claim 1, wherein the Si/Al molar ratio of said silico-aluminous compound varies from 0.1 to 6.

6. The dry geosynthetic binder composition according to claim 5, wherein the Si/Al molar ratio of said silico-aluminous compound varies from 1 to 4.

7. The dry geosynthetic binder composition according to claim 1, comprising, by weight, as compared to the dry binder composition total weight, from 65 to 85% of said silico-aluminous compound, from 5 to 20% of hydrated lime and from 10 to 25% of an alkaline salt.

8. The dry geosynthetic binder composition according to claim 1, wherein said alkaline salt is selected from potassium carbonate, sodium carbonate, potassium silicate, sodium silicate or any combination thereof.

9. The dry geosynthetic binder composition according to claim 1, comprising a sulfate source.

10. A material comprising a soil, an aggregate or the mixture thereof, characterized in that it comprises water and a geosynthetic binder dry composition according to claim 1.

11. The material according to claim 10, wherein the binder dry composition represents, by weight, as compared to said material total weight, from 1 to 30%.

12. The material according to claim 11, wherein the binder dry composition represents, by weight, as compared to said material total weight, from 2 to 20%.

13. The material according to claim 10, wherein a fraction of sulfates, sulfides or other sulfur-type elements is present, in an amount ranging from 0.7 to 20% by weight, as compared to the material total weight.

14. A method for producing a geosynthetic binder dry composition according to claim 1, comprising at least the following step: mixing for a time period ranging from 0.5 minutes to 15 minutes, in a powder mixer of an alkalino-calcium type activator comprising lime and an alkaline salt, with a silico-aluminous compound comprising an amount of calcium oxide higher than or equal to 15%, by weight, as compared to the silico-aluminous compound total weight.

15. A method for producing a material comprising a soil, an aggregate or a mixture thereof, and a geosynthetic binder dry composition, comprising at least the following steps:
i) preparing the binder dry composition according to claim 14;
ii) preparing a soil, an aggregate or the mixture thereof optionally containing a sulfate source;
iii) spreading said dry binder composition onto the soil and/or the aggregate beforehand overlaid during step (ii);
iv) mixing the soil and/or the aggregate obtained at the end of step (iii);
v) optionally, adding mixing water during steps ii) to iv) before, during or after the mix-in place of the binder dry composition with the soil and/or the aggregate, so as to obtain said material.

16. The method for producing a material according to claim 15, wherein steps (iii) and (iv) are replaced with a process in a central plant, continuously or discontinuously, prior to using said material on a work site.

17. The material according to claim 11, wherein a fraction of sulfates, sulfides or other sulfur-type elements is present, in an amount ranging from 0.7 to 20% by weight, as compared to the material total weight.

18. The dry geosynthetic binder composition according to claim 2, wherein said silico-aluminous compound comprises, by weight, as compared to the total weight, at least from 25 to 55% of calcium oxide (CaO), from 3 to 25% of alumina (Al₂O₃) and from 20 to 50% of SiO₂.
